(19) United States
(12) Patent Application Publication
(10) Pub. No.: US 2014/0292694 A1
(43) Pub. Date: Oct. 2, 2014

(54) DISPLAY CONTROL APPARATUS AND DISPLAY CONTROL METHOD

(71) Applicant: MStar Semiconductor, Inc., Hsinchu Hsien (TW)

(72) Inventors: Sheng-Yueh Lin, Zhubei City (TW); Jiunn-Kuang Chen, Zhubei City (TW); Chi-Chun Cheng, Zhubei City (TW); Chieh-Huang Tu, Zhubei City (TW); Meng-Che Tsai, Zhubei City (TW)

(73) Assignee: MStar Semiconductor, Inc., Hsinchu Hsien (TW)

(21) Appl. No.: 14/228,385

(22) Filed: Mar. 28, 2014

(30) Foreign Application Priority Data
Apr. 2, 2013 (TW) 102111933

(51) Int. Cl. G06F 3/041

(52) U.S. Cl. CPC G06F 3/0416
USPC 345/173

(57) ABSTRACT

A display control device for controlling a display apparatus is provided. The display apparatus includes a touch panel and is for displaying an image signal of a computer host. The display control device includes a touch panel controller and a screen controller. The touch panel controller controls the touch panel to perform touch sensing and accordingly generates a touch control signal. The screen controller controls the display apparatus to operate between an adjustment mode and a display mode according a mode signal. When the display apparatus operates in the adjustment mode, the screen controller performs on-screen display (OSD) control according to the touch control signal to adjust the display apparatus. When the display apparatus operates in the display mode, the touch control signal is transmitted to the computer host to control the computer host.

This application claims the benefit of Taiwan application Serial No. 102111933, filed Apr. 2, 2013, the subject matter of which is incorporated herein by reference.

### BACKGROUND OF THE INVENTION

1. Field of the Invention

The invention relates in general to a display control device and an associated method, and more particularly to a display control device for providing on-screen display (OSD) control with reduced costs, simplified architecture and enhanced functionality, and an associated method.

2. Description of the Related Art

A display apparatus, e.g., a monitor that operates in collaboration with a computer host, provides a user with a visual human-man interface (HMI), and is applied as one of the most critical and prominent components in modern electronic/computer systems. In the recent years, a display apparatus is integrated with a display function and a touch sensing function of a touch screen, in a way that the HMI provides even more friendly and intuitive operations.

To adjust and/or configure displaying functions and parameters of a display apparatus, the display apparatus needs to support on-screen display (OSD) control, e.g., adjustment for brightness, contrast, color adjustment coefficients and/or color temperature of a display image. In a conventional display apparatus, the adjustment function and touch sensing function of a touch screen are mutually independent. FIG. 1 shows a schematic diagram of an internal architecture of a display apparatus that supports a touch sensing function. Referring to FIG. 1, a display apparatus 100 includes a touch screen 12, a screen controller 13, a touch panel controller 15, a USB interface 17, and a video interface 19. The screen controller 13 controls various functions of the display apparatus 100, and receives video signals transmitted from a computer host 14 via the video interface 19, performs processes including scaling, color adjustment and brightness adjustment on the video signals, and outputs the processed signals to a display panel 11b of the touch screen 12. The touch panel controller 15 controls a touch panel 11a to sense a touch instruction inputted by a user to accordingly generate a touch control signal. The touch control signal generated by the touch panel controller 15 is directly transmitted to the computer host 14 via the USB interface 17. Although being combined into one unit, the hardware in the conventional display apparatus 100 cannot be shared with respect to functions. The touch sensing result that the touch panel 11a generates from sensing the user touch is transmitted to the computer host via the USB interface 17 (e.g., a Universal Serial Bus (USB) 2.0 communication interface) dedicated for touch sensing. The computer host provides corresponding media contents/image signals according to the sensing result, and transmits the image signals carrying the media contents back the display apparatus 100 for display via the video interface 19 (e.g., a Video Graphic Array (VGA), Digital Video Interface (DVI) or High-Definition Multimedia Interface (HDMI)) for display. Since data is not exchanged between the USB interface 17 dedicated for touch sensing and the video interface 19 dedicated for display, the touch function of the conventional display apparatus is for the sole use of the computer host and cannot be utilized for OSD control of the display apparatus 100. Therefore, although the conventional display apparatus 100 is integrated with a touch screen, multiple physical keys, buttons and/or turntables need to additionally provide in order to allow a user to control the OSD. It is apparent that such conventional solution increases costs and complications of OSD control and thus disfavors the prevalence of touch screens.

Further, in the prior art, the OSD of the display apparatus is controlled by a screen controller of the display apparatus. The screen controller generates an associated image for controlling the OSD and for prompting a user to adjust settings and parameters of functions of the display apparatus. Computation functions of the OSD controller are simpler and support limited OSD control functions. As functions of a display apparatus are increasing becoming more diversified in a way that the number of configurable functions and adjustable parameters are also expanding, the required OSD control also becomes more sophisticated. Therefore, the conventional solution gradually fails to the meet the development trend of modern display apparatuses.

### SUMMARY OF THE INVENTION

The invention is directed to a technique capable of supporting OSD control by utilizing a touch control function of a touch screen in a display apparatus.

According to an object of the present invention, a display control device that controls a display apparatus is provided. The display apparatus includes a touch panel, and is configured to display an image signal of a computer host. The display control device of the present invention includes a touch panel controller and a screen controller. The touch panel controller controls the touch panel to perform touch sensing and accordingly generates a touch control signal. The screen controller controls the display apparatus to operate between an adjustment mode and a display mode according to a mode signal. When the display apparatus operates in the adjustment mode, the screen controller performs on-screen display (OSD) control according to the touch control signal to adjust the display apparatus. When the display apparatus operates in the display mode, the touch control signal is transmitted to the computer host to control the computer host.

A display control method for controlling a display apparatus is further provided by the present invention. The display apparatus includes a touch panel, and is configured to display an image signal of a computer host. The display control method of the present invention includes: controlling the touch panel to perform touch sensing and accordingly generating a touch control signal; controlling the display apparatus to operate between an adjustment mode and a display mode; when the display apparatus operates in the adjustment mode, performing OSD control according to the touch control signal to adjust the display apparatus; and when the display apparatus operates in the display mode, transmitting the touch control signal to the computer host to control the computer host.

A display control device for controlling a display apparatus is further provided by the present invention. The display apparatus includes a touch panel, and is configured to display an image signal of a computer host. The display control device of the present invention includes a touch panel controller and a screen controller. The touch panel controller is configured to control the touch panel to perform touch sensing and to accordingly generate a touch control signal, such that the computer host generates a control signal according to the touch control signal. The screen controller is configured to perform OSD control according to the control signal to adjust the display apparatus.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a display apparatus of the prior art;

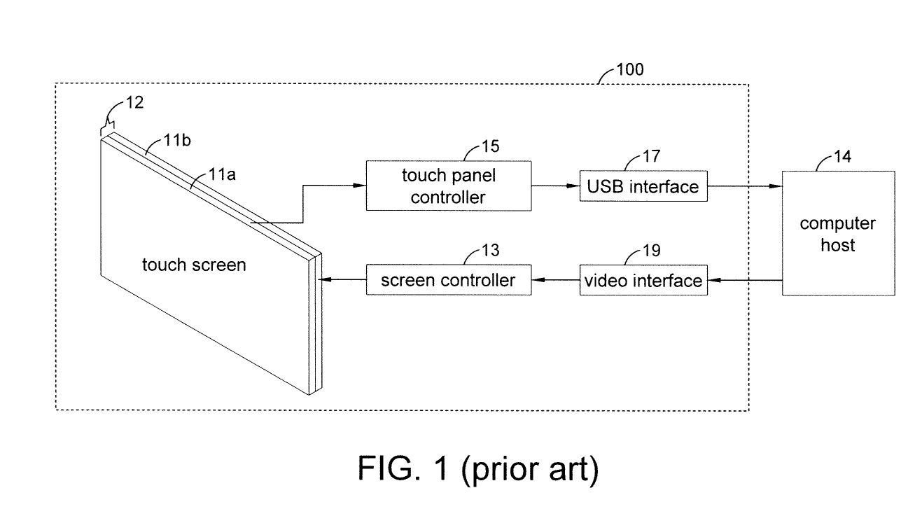

FIG. 2 is a schematic diagram of a display apparatus operating in collaboration with a computer host according to an embodiment of the present invention;

FIG. 3 is a block diagram of a screen controller of a display control device according to an embodiment of the present invention;

FIG. 4 is a schematic diagram of a display apparatus operating in collaboration with a computer host according to another embodiment of the present invention;

FIG. 5 is a schematic diagram of a display apparatus operating in collaboration with a computer host according to yet another embodiment of the present invention; and

FIG. 6 is a schematic diagram of exemplary operations of the display apparatus in FIG. 5.

### DETAILED DESCRIPTION OF THE INVENTION

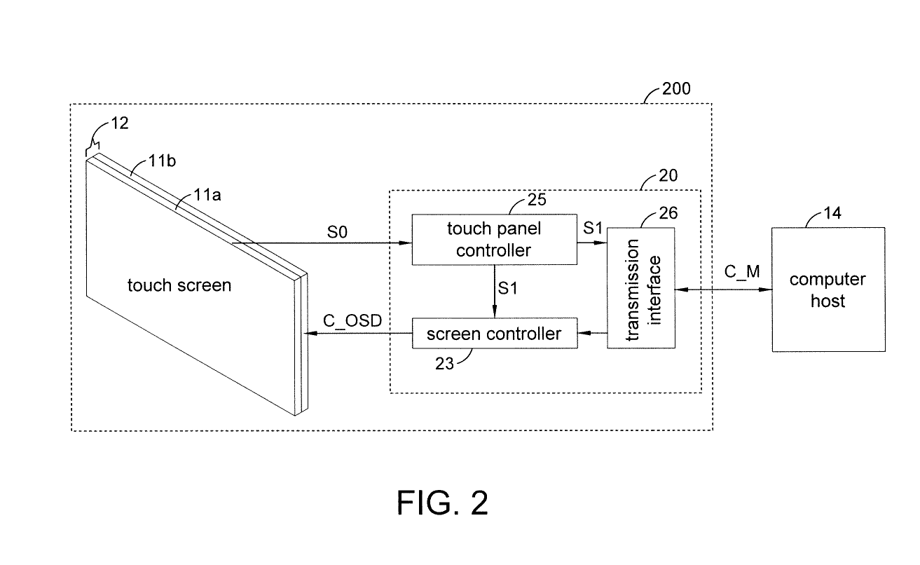

FIG. 2 shows a schematic diagram of a display apparatus 200 operating in collaboration with a computer host 14 according to an embodiment of the present invention. For example, the display apparatus 200 may be a computer system monitor that operates in collaboration with the computer host 14. The display apparatus 200 includes a touch screen 12 and a display control device 20. The display control device 20 includes a touch panel controller 25, a screen controller 23 and a transmission interface 26. The touch screen 12 may be integrated with a touch panel 11a and a display panel 11b. The touch panel controller 25, coupled to the touch panel 11a of the touch screen 12, controls the touch panel 11a to sense touch control of a user and provides a corresponding touch control signal S1 according to a sensing signal S0 generated by the touch panel 11a. For example, the touch panel controller 25 may provide an appropriate timing signal that triggers the touch panel 11a to perform sensing scanning, and capture coordinates (of a single touch point or multiple touch points), and/or a trajectory, gesture and timing (e.g., the duration that a user continuously touches particular coordinates) of the touch control from the sensing signal S0. The screen controller 23 controls operations of the display panel 11b of the display apparatus 200. In the embodiment, the transmission interface 26 is disposed between the display apparatus 20 and the computer host 14 to realize a bi-directional transmission interface.

The screen controller 23 generates a mode signal according to an instruction entered by a user, and accordingly controls the display apparatus 200 to operate between an adjustment mode and a display mode. In the adjustment mode, the user may perform OSD control of the display apparatus 200 by means of touch control to adjust and set display functions and parameters of the display apparatus 200. Details of the display apparatus 200 operating in the adjustment mode are described below. After the display apparatus 200 enters the adjustment mode, the screen controller 23 provides an OSD content C_OSD to the display panel 11b, such that the display panel 11b of the touch screen 23 presents the OSD content C_OSD to the user to prompt the user to set and adjust the OSD control. For example, the touch screen 12 may list all configurable/adjustable items in form of a graph, and parameter ranges of the listed items. The user may then directly set and adjust the OSD control by means of touch control on the touch screen 12 according to the prompt of the touch screen 12. The touch control performed by the user on the touch panel 11a is sensed as the sensing signal S0, and the corresponding touch signal S1 is provided by the touch panel controller 25.

In the adjustment mode, the touch control signal S1 is transmitted to the screen controller 23. For example, when the screen controller 23 provides the OSD content C_OSD, the touch screen 12 may be divided into different regions that respectively correspond to different function items, parameters, parameter ranges, and/or setting options of the OSD control. The screen controller 23 compares to which of the regions that the touch control coordinates in the touch control signal S1 match, so as to determine the item/parameter/parameter range and/or setting option selected by the user. In another embodiment, the screen controller 23 may also determine the corresponding user instruction according to whether a touch control behavior in the touch control signal S1 satisfies a predetermined pattern. For example, a slider region may be divided and/or displayed on the touch screen 12 to correspond to a predetermined parameter in the OSD control. When the touch control trajectory in the touch control signal S1 reflects that the user touch control moves from the left to the right in the slider region, it means that the user wishes to increase the parameter. Conversely, when the pattern of the trajectory reflects that the user touch control moves from the right to the left in the slider region, it means that the user wishes to decrease the parameter. Alternatively, when the trajectory in the touch control signal S1 reflects that the user touch control poses two touch points that approach each other in the slider region, the parameter is to be decreased, or else the parameter is to the increased when the touch points gradually get farther away from each other.

After obtaining the user instruction from the touch control signal S1, the screen controller 23 learns the settings and adjustments that the user wishes to perform from the user instruction to accordingly control the functions and display parameters of the display apparatus 200. Thus, the user is allowed to directly perform OSD control of the display apparatus 200 by means of touch control.

Details of how the screen controller 23 controls the display apparatus 200 to operate in the display mode are described below. In the display mode, the sensing signal S0 sensed by the touch screen 12 is converted to the corresponding touch sensing signal S1 by the touch panel controller 25. The touch control signal S1 is transmitted to the computer host 14 via the transmission interface 26, so that the computer host 14 correspondingly operates according to the touch control signal S1. In the embodiment in FIG. 2, an image signal C_M provided by operations of the computer host 14 is received via the transmission interface 26 by the screen controller 23 and processed by the screen controller 23, and then displayed on the touch screen 12. In other words, in the display mode, the user may control/instruct operations of the computer host 14 by means of touch control on the touch screen 12, and view the operations. For example, the transmission interface 26 may be implemented by a high-speed, high-bandwidth wired or wireless bi-directional communication interface standard for transmitting and receiving signals, e.g., the USB 3.0 (and onwards) or Mobile High-Definition Link (MHL) standard.

It is known from the above discussion that, the display apparatus 200 of the present invention is capable of not only supporting the display mode for the computer host 14 but also realizing the adjustment mode through the touch screen 12, thereby allowing a user to intuitively set and adjust the OSD control by means of touch control. As the adjustment mode is operable by touch control, the display apparatus 200 does not require multiple additional physical keys, buttons, and/or turntables for supporting the OSD control. Thus, the present invention offers the display apparatus 200 with a simpler architecture and lower costs and yet more user-friendly operations.

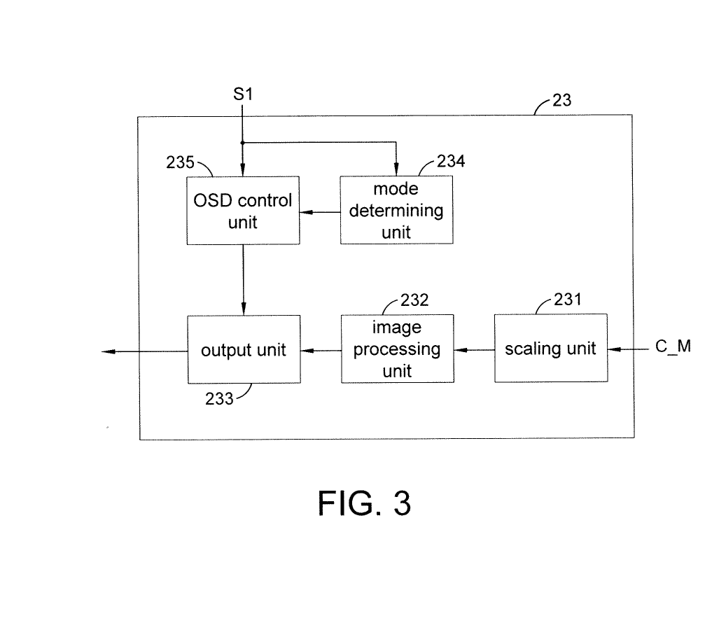

FIG. 3 shows a block diagram of a screen controller of a display control device according to an embodiment of the present invention. In the embodiment, the screen controller 23 includes a scaling unit 231, an image processing unit 232, an output unit 233, a mode determining unit 234, and an OSD control unit 235. The scaling unit 231 performs an appropriate scaling process on the image signal C_M from the computer host 14 according to a resolution of the display panel 11b. The image processing unit 232 processes the scaled image signal to adjust the brightness, contrast and colors of the scaled image signal. The output unit 233 outputs the processed image signal to the display panel 11b. The mode determining unit 234 generates a mode signal according to a user-entered user instruction.

In one embodiment of the present invention, the user may switch the display apparatus 200 between the display mode and the adjustment mode by means of touch control. For example, when the display apparatus 200 operates in the display mode, the touch control signal S1 is transmitted to the computer host 14 via the transmission interface 26, and the mode determining unit 234 in the screen controller 23 further continuously compares whether the touch control signal S1 satisfies a predetermined mode switching condition. If so, the mode determining unit 234 generates a corresponding mode signal so that the display apparatus 200 accordingly switches to the adjustment mode. For example, the mode switching condition may be continuously touching a corner or a predetermined position of the touch screen 12 for a period of time, clicking the touch screen 12 for a predetermined number of times, and/or drawing a predetermined gesture on the touch screen 12. After the display apparatus 200 enters the adjustment mode, the OSD control unit 235 determines the user instruction according to the touch control signal S1, and generates a corresponding OSD content C_OSD to the output unit 233. The output unit 233 superimposes the OSD content and the processed image signal outputted from the image processing unit 232, and outputs the superimposed result to the display panel 11b of the touch screen 12, such that the display panel 11b displays the image superimposed with the OSD content. Further, the OSD control unit 235 may display/divide a predetermined region on the touch screen 12 for the user to input whether to switch back to the display mode from the adjustment mode. When the user touches the region, the display apparatus 200 is switched back to the display mode. Further, the adjustment mode and the display mode may be simultaneously performed. More specifically, a region may be partitioned on the touch screen for the OSD control, with touch control within the region corresponding to the OSD control, and touch control outside the region corresponding to the display mode and transmitted to the computer host 14 via the transmission interface 26.

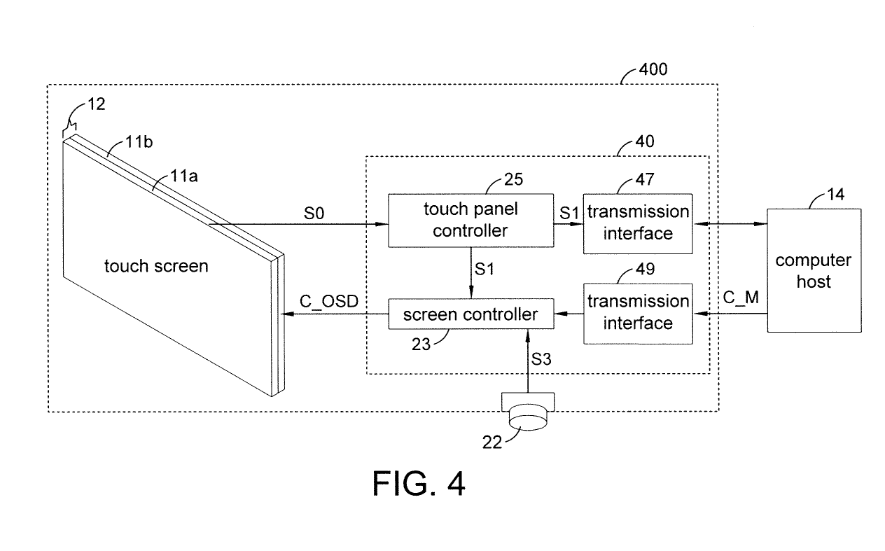

In another embodiment of the present invention, one single physical button/key may be disposed to control the switching between the display mode and the adjustment mode, as a display apparatus 400 in FIG. 4. The display apparatus 400 is additionally provided with a key 22 coupled to the screen controller 23. The key 22 receives a user press and provides a corresponding key instruction S3 to the mode determining unit 234 in the screen controller 23. According to the key instruction S3, the mode determining unit 234 generates the corresponding mode signal to prompt the display apparatus 400 to switch between the display mode and the adjustment mode.

FIG. 4 also shows a schematic diagram of a transmission interface established between a display control device 40 in the display apparatus 400 and the computer host 14 according to another embodiment of the present invention. The display control device 40 may include two different transmission interfaces 47 and 49, which adopt different transmission interface standards. When the display apparatus 400 operates in the display mode, the touch control signal S1 that the touch panel controller 25 generates according to the sensing signal S0 is transmitted to the computer host 14 via the transmission interface 47. The image signal C_M provided by the computer host 14 is transmitted to the screen controller 23 of the display control device 40 via the transmission interface 49. The transmission interface 47 may adopt a low-cost communication interface having a narrower bandwidth and a slower transmission speed, e.g., the USB 2.0 standard. The transmission interface 49 may adopt a communication interface standard having a high bandwidth and a high transmission speed, e.g, a VGA, DVI or HDMI video interface.

The key 22 may serve for mode switching as well as other functions, e.g., a power switch. For example, the user may press the key 22 once to power on and operate the display apparatus 400. When the user quickly presses the key 22 twice, the display apparatus 400 may be switched from the display mode to the adjustment mode.

It is known from FIG. 2 and FIG. 4 that, the display panel controller 25 of the display control device of the present invention is capable of transmitting the touch control signal to the screen controller 23, and so the user is allowed to set and adjust the OSD control by means of touch control in a convenient, user-friend and intuitive manner. Further, by disposing one single key (as shown in FIG. 4), or completely eliminating a physical key (as shown in FIG. 2), the present invention also provides the display apparatus with a simple hardware architecture.

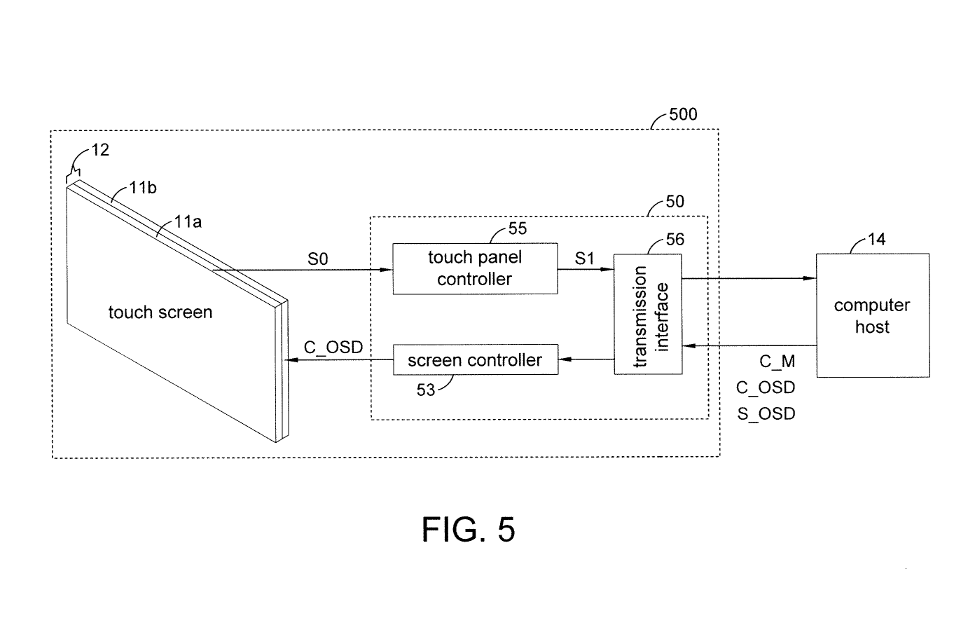

FIG. 5 shows a schematic diagram of a display apparatus 500 according to another embodiment of the present invention. The display apparatus 500 may operate in collaboration with the computer host 14 to implement OSD control. The display apparatus 500 includes a touch screen 12 and a display control device 50. The display control device 50 includes a screen controller 53, a touch panel controller 55, and a transmission interface 56. The touch screen 12 includes a touch panel 11a and a display panel 11b. The touch panel 11a senses a user touch control to provide a corresponding sensing signal S0. The display panel 11b receives the control of the screen controller 53 to perform image display. The touch panel controller 55 is coupled to the touch panel 11a of the touch screen 12, and provides a corresponding touch control signal 51 according to the sensing signal S0. The transmission interface 56, coupled to the touch panel controller 55 and the screen controller 53, establishes a bi-directional communication interface between the display apparatus 500 and the computer host 14.

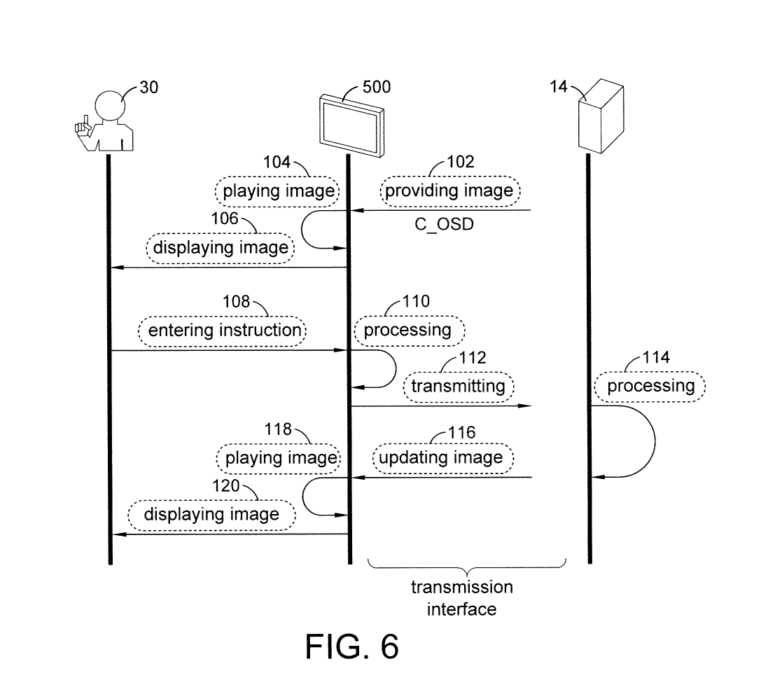

In the embodiment, the computer host 14 is installed with a control program associated with the display apparatus 500 in advance, and the user is enabled to control the display apparatus 500 through the computer host 14 via the control program to enter OSD control in the adjustment mode, and to set and adjust the display apparatus 500 through the touch screen 12 via the OSD control. Operations of the display apparatus 500 and the computer host 14 in the adjustment mode are illustrated with reference to the steps in FIG. 6.

In step 102, when a user 30 is to perform OSD control on the display apparatus 500 in the adjustment mode, the computer host 14 may provide an OSD content C_OSD via the communication interface established by the transmission interface 56 to the display apparatus 500.

In step 104, the display apparatus 500 displays an image corresponding to the OSD content C_OSD.

In step 106, the image presented by the display apparatus 500 prompts the user 30 to set and adjust the OSD control. For example, the OSD content C_OSD may present items, adjustable parameters and values/value ranges, and configurable/selectable function items of the OSD control.

In step 108, the user 30 may enter an instruction by means of touch control on the touch screen 12 of the display apparatus 500 to set/adjust the functions/parameters of the items of the OSD control.

In step 110, after sensing the user control instruction, the touch panel 11a of the touch screen 12 of the display apparatus 500 generates a sensing signal (FIG. 5), which is converted into a touch control signal S1 by the touch panel controller 55.

In step 112, the touch control signal S1 is transmitted to the computer host 14 via the transmission interface 56.

In step 114, the computer host 14 learns the adjustments and/or settings that the user 30 wishes to perform, and generates a corresponding remote instruction S_OSD (FIG. 5). According to the user instruction, the computer host 14 provides an updated image signal C_M or the OSD content C_OSD. For example, when subsequent OSD control is to be performed, the computer host 14 may provide the updated OSD content C_OSD in response to the subsequent OSD control. When the OSD control is complete, the computer host 14 may provide the updated image signal C_M.

In step 116, the remote instruction S_OSD, the update image signal C_M, and/or the OSD content C_OSD may be transmitted to the display apparatus 500.

In step 118, the display apparatus 500 performs the OSD control according to the remote instruction S_OSD, and displays the image signal C_M or the OSD content C_OSD.

In step 120, the user 30 views the contents displayed by the display apparatus 500.

It is known from the above discussion that, the display apparatus 500 of the present invention hands the OSD control in the adjustment mode to the computer host 14. Further, the computer host 14 provides the image for the OSD control in the OSD content C_OSD, and controls the OSD control of the display apparatus 500 by the remote instruction S_OSD. With powerful computation functions of the computer host 14, a versatile and sophisticated OSD control image is provided to enhance functions of the OSD control. For example, the computer host 14 may provide a preview of adjustment/setting result for the OSD control, and present images corresponding to different settings in a vertical or in horizontal arrangement for facilitating the user to select appropriate parameters and settings. For another example, by an audio function of the display apparatus 500, the computer host 14 may prompt the user to perform the OSD control, or play dynamic tutorial images for adjustment and configuration to guide the user to select settings and adjustments that meet user requirements. Alternatively, non-volatile storage resources in the computer host 14 may be utilized to archive the OSD control, or record different setting parameters of different playback scenarios, e.g., settings and adjustments according to personal preferences of different users. Further, the computer host 14 may support the OSD control of the display apparatus 500 by drivers of software/firmware and/or hardware.

The concepts in FIGS. 5 and 6 of the present invention may also be further extensively applied. For example, services, applications and functions originally provided by the screen controller 53 may be performed by the computer host 14 instead. With more powerful computation functions of the computer host, these services, applications and functions can be reinforced.

The screen controller 53 of the display apparatus 500 and the computer host 14 may also share the OSD control. For example, the screen controller 53 may provide a preliminary image of the OSD control, and the computer host 14 may provide a more detailed and advanced image if a user needs an advanced image (e.g., a preview of adjustment/configuration result). Alternatively, by incorporating the concept in FIG. 2, certain items in the OSD control may be forwarded via the touch panel controller 55 to the screen controller 53 for further processing, and the adjustments and settings of other items are forwarded via the transmission interface 56 to the computer host 14 for further processing.

As shown in FIG. 5, the display apparatus 500 of the present invention may establish a bi-directional communication interface with the computer host 14 by one single transmission interface 56. For example, when the user wishes to rotate the touch screen 12 by 90 degrees and thus changing a display aspect ratio (i.e., to change a screen display of M*N pixels to N*M pixels), the display apparatus 500 may transmit an operation signal of the user to the computer host 14 via the transmission interface 56. The computer host 14 then correspondingly updates the image signal C_M (e.g., correspondingly changing the aspect ratio), and transmits the updated image signal to the display apparatus 500 via the transmission interface 56. When required, the display control device 50 may call the software/hardware that performs image scaling in the display apparatus 500 to appropriately scale the image in the image signal C_M, so that the display apparatus 500 may display the image with the changed aspect ratio. For example, the transmission interface 56 may be implemented by a high-speed, high-bandwidth bi-directional communication interface standard, e.g., the USB 3.0 (and onwards) or MHL standard.

In conclusion, with the embodiments of the present invention, not only the hardware structure for the OSD control is effectively simplified, but also a more convenient, user-friendly and intuitive and/or more sophisticate and elaborate user interface is provided for the OSD control.

While the invention has been described by means of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display control device, for controlling a display apparatus, the display apparatus comprising a touch panel and configured to display an image signal of a computer host, the display control device comprising:
a touch panel controller, configured to control the touch panel to perform touch sensing and to accordingly generate a touch control signal; and
a screen controller, configured to control the display apparatus to operate between an adjustment mode and a display mode according to a mode signal;
wherein, when the display apparatus operates in the adjustment mode, the screen controller performs on-screen display (OSD) control according to the touch control signal to adjust the display apparatus; when the display apparatus operates in the display mode, the touch control signal is transmitted to the computer host.

2. The display control device according to claim 1, further comprising:
a transmission interface, configured to transmit the touch control signal to the computer host.

3. The display control device according to claim 1, wherein the touch panel controller and the screen controller are connected to the computer host via a same transmission interface.

4. The display control device according to claim 3, wherein the transmission interface is one of a Universal Serial Bus (USB) and Mobile High-definition Link (MHL) interface.

5. The display control device according to claim 3, wherein when the display apparatus operates in the adjustment mode, an image of the OSD control is generated by the computer host and transmitted to the screen controller via the transmission interface.

6. The display control device according to claim 1, wherein the screen controller comprises a mode determining unit configured to generate the mode signal according to the touch control signal.

7. The display control device according to claim 1, wherein the display apparatus further comprises a key configured to generate a key instruction, and the screen controller comprises a mode determining unit configured to generate the mode signal according to the key instruction.

8. A display control method, for controlling a display apparatus, the display apparatus comprising a touch panel and configured to display an image signal of a computer host, the display control method comprising:
controlling the touch panel to perform touch sensing and accordingly generating a touch control signal; and
controlling the display apparatus to operate between an adjustment mode and a display mode according to a mode signal;
wherein, when the display apparatus operates in the adjustment mode, OSD control is performed according to the touch control signal to adjust the display apparatus; when the display apparatus operates in the display mode, the control signal is transmitted to the computer host.

9. The display control method according to claim 8, wherein the mode signal is generated according to the touch control signal.

10. The display control method according to claim 8, wherein the display apparatus further comprises a key configured to generate a key instruction, and the mode signal is generated according to the key instruction.

11. The display control method according to claim 8, wherein when the display apparatus operates in the adjustment mode, an image of the OSD control is generated by the computer host and transmitted to the display apparatus.

12. A display control device, for controlling a display apparatus, the display apparatus comprising a touch panel and configured to display an
image signal of a computer host, the display control device comprising:
a touch panel controller, configured to control the touch panel to perform touch sensing and to accordingly generate a touch control signal, such that the computer host generates a control signal according to the touch control signal; and
a screen controller, configured to perform OSD control according to the control signal to adjust the display apparatus.

13. The display control device according to claim 12, further comprising:
a transmission interface, configured to transmit the touch control signal to the computer host;
wherein, the touch panel controller and the screen controller are connected to the computer host via the transmission interface.

14. The display control device according to claim 13, wherein the transmission interface is one of a USB and MHL interface.

15. The display control device according to claim 12, wherein an image of the OSD control is generated by the computer host and transmitted to the screen controller.
